(19) United States
(12) Patent Application Publication
(10) Pub. No.: US 2025/0329768 A1
(43) Pub. Date: Oct. 23, 2025

(54) SAFETY AND SUPPORT SYSTEM FOR A FUEL CELL MODULE

(71) Applicant: CORVUS ENERGY AS, Nesttun (NO)

(72) Inventors: Erlend VAKTSKJOLD, Nesttun (NO); Thor HUMERFELT, Nesttun (NO); Kristian EIKELAND HOLMEFJORD, Nesttun (NO)

(21) Appl. No.: 18/875,491

(22) PCT Filed: Jun. 20, 2023
(86) PCT No.: PCT/NO2023/050145

§ 371 Date: Dec. 16, 2024

(30) Foreign Application Priority Data
Jun. 20, 2022 (NO) 20220699

(51) Int. Cl. H01M 8/2475; H01M 8/0432; H01M 8/0438; H01M 8/0444; H01M 8/04664; H01M 8/04746; H01M 8/0662

(52) U.S. Cl. CPC H01M 8/2475; H01M 8/04358; H01M 8/04425; H01M 8/0444; H01M 8/04679; H01M 8/04761; H01M 8/04776; H01M 8/0662

(57) ABSTRACT

Described herein is a safety and support system for a fuel cell module comprising: a pressure-tight safety casing for enclosing the fuel cell module and for containing a fluid; a fuel supply system, arranged to transport fuel to the fuel cell module from an external source; an air supply system, arranged to transport air to the fuel cell module from an external source, an exhaust system, arranged to transport exhaust fluids from the fuel cell module out of the safety casing, and a casing atmosphere system comprising: an inlet into the safety casing having an inlet valve, an outlet from the safety casing having an outlet valve, means for evacuating the fluid from the safety casing through the outlet, and a pressure sensor, arranged for measuring a pressure of the fluid inside the safety casing, wherein the casing atmosphere system is arranged to maintain a below ambient pressure inside the safety casing. Also described herein is a method for preventing an explosive atmosphere inside a safety casing and a fuel cell system for marine applications.

### FIELD OF THE INVENTION

The present invention relates to a safety and support system for a fuel cell module. The invention relates particularly to a safety and support system for a fuel cell module comprising a hydrogen fuel cell.

### BACKGROUND OF THE INVENTION

A fuel cell is an electrochemical device that converts chemical energy that is produced by a reaction directly into electrical energy. For example, one type of fuel cell includes a proton exchange membrane (PEM), often called a polymer electrolyte membrane, which permits only protons to pass between an anode and a cathode of the fuel cell. At the anode, diatomic hydrogen (a fuel) reacts to produce hydrogen protons which pass through the PEM. The electrons produced by this reaction travel through circuitry that is external to the fuel cell to provide an electrical current. At the cathode, oxygen is reduced and reacts with the hydrogen protons to form water. The anodic and cathodic reactions are described by the following equations:

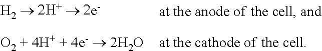

Because a single fuel cell typically produces a relatively small voltage (around 1 volt, for example), several fuel cells may together form an arrangement, called a fuel cell stack, in order to produce a higher voltage. The fuel cell stack may include plates (graphite composite or metal plates, as examples) that are stacked one on top of the other, and each plate may be associated with more than one fuel cell of the stack. The plates may include various channels and orifices to, for example, route the reactants and products through the fuel cell stack. Several PEMs (each one being associated with a particular fuel cell) may be dispersed throughout the stack between the anodes and cathodes of the different fuel cells.

The fuel cell stack, local control unit, and core components vital for the power generation are often arranged together in one fuel cell module. Such fuel cell modules are often based on the components of a fuel cell system used in a car. These components, which can be positioned at spaced apart locations inside a fuel cell vehicle/car can be arranged in a compact module for other applications and are commercially available.

Hydrogen (H₂), in particular, is a very light gas and a very small molecule that is challenging to contain inside any system. Leaks can easily occur, and hydrogen tends to diffuse to the surroundings from any system where it is used.

In a fuel cell module, such as the one described above, small amounts of fuel (hydrogen in some cases) will over time leak to the surroundings. Normally in fuel cell applications, such as in hydrogen cars, such small amounts of fuel are diluted into the ambient air before an explosive mixture with oxygen can form. This is possible because the fuel cell module is arranged in a well-ventilated compartment and the car is used outdoors.

The use of hydrogen as a fuel has become more common the recent years. The use of fuel cells has lately also been considered as a step towards decarbonizing transportation at sea. There are, however, challenges still to be solved before fuel cell technology can be widely used onboard ships and other seagoing vessels.

One important difference when placing a fuel cell onboard a ship compared to inside a car is that it may be desirable to install the fuel cell inside a confined space below deck. As a result, any leakage of fuel, such as hydrogen which is very flammable, might result in an explosive atmosphere inside said confined space. In the automotive industry the safety philosophy for avoiding an explosive atmosphere is to let the ambient air flow around the outside of the fuel cell components, so that any leakage of hydrogen will diffuse before concentrations reach what is considered to be an explosive atmosphere. This philosophy is not so suitable for a ship as for a car since the systems on ships are larger (hence, more hydrogen tends to leak out) and they may be placed in confined spaces that will require extensive forced ventilation systems that will reduce the efficiency of the overall system.

Similar challenges exist in relations to other types of fuel cells, and will apply in the case of fuel cells using hydrogen as fuel such as PEM fuel cells, in alkaline fuel cells, solid oxide fuel cells and fuel cells for other types of fuel such as natural gas fuel cells, ammonia fuel cells and methanol fuel cells.

### DISCLOSURE OF THE STATE OF ART

WO0159861A2 discloses a fuel cell system including a fuel cell stack, an enclosure housing the fuel cell stack and a blower. The blower is located inside the enclosure and is adapted to draw air from inside the enclosure to produce an air flow through the fuel cell stack and establish a negative pressure inside the enclosure with respect to a region outside of the enclosure. Air drawn into the enclosure is passing through a filter. The filter introduces a pressure drop, that produces the negative pressure inside the enclosure. The negative pressure can only be maintained as long as the blower is drawing air out of the enclosure.

JP2005268054A discloses a solution for suppressing an abnormal state in a fuel cell system with the aim of providing a solution that is compact and can be used in a vehicle. The abnormal state is suppressed by displacing oxygen so that the concentration of oxygen is too low for a fire to start. The document teaches that instead of providing inert gas to displace oxygen, which would make the system large and heavy, hydrogen or cooling water is used to displace oxygen. Hydrogen and cooling water must anyway be available to operate the fuel cell. Such a system for displacing oxygen will not add much weight or volume to the fuel cell system. So, the fuel cell system can remain compact and at the same time be able to suppress an abnormal state.

JP2009046128A discloses a heat insulating container having at least a part of the container shell equipped with a surface variable mechanism that switches the surface of the container shell between a flat surface state and a fine uneven surface state. The container can accommodate a fuel cell and a fuel cell produces heat during operation. The amount of heat produced by the fuel cell depends on the operational load. The problem to be solved by the container is to control heat insulation and heat dissipation according to the heat generation on the inside of the container.

### OBJECTS OF THE PRESENT INVENTION

One objective of the invention is to provide a safety and support system for a standard fuel cell module that prevents the formation of an explosive atmosphere around the fuel cell module, i.e. preventing an explosive mixture of fuel and oxygen, in particular when hydrogen is the fuel.

Another objective of the invention is to enhance the ability to detect a leak or abnormal condition which might lead to the formation of an explosive atmosphere in relation to a fuel cell (such as a mixture of hydrogen and oxygen when hydrogen is the fuel and air is fed into the cell).

Yet another objective of the invention is to provide an enclosure with a safety and support system that makes a standard industrial fuel cell module normally intended for use in air ventilated surroundings suitable for use on a ship where it is accommodated in a confined space, for example in a machine room below deck. This will be in particular to prevent the formation of an explosive atmosphere in said confined space.

### SUMMARY OF THE INVENTION

The invention relates in a first aspect to a safety and support system for a fuel cell module. The system comprises:
a pressure-tight safety casing for enclosing the fuel cell module and for containing a fluid in a space between the fuel cell module and the safety casing,
a fuel supply system, arranged to transport fuel to the fuel cell module from an external source outside the safety casing.
an air supply system, arranged to transport air to the fuel cell module from an external source outside the safety casing,
an exhaust system, arranged to transport exhaust fluids from the fuel cell module out of the safety casing isolated from the space between the fuel cell module and the safety casing, and
a casing atmosphere system comprising:
   an outlet from the safety casing having an outlet valve,
   an inlet having an inlet valve for controlling intake of the fluid into the safety casing (i.e. into the space between the fuel cell module and the safety casing)
   means for evacuating the fluid from the safety casing through the outlet, and
   a pressure sensor, arranged for measuring a pressure of the fluid inside the safety casing.

The casing atmosphere system is arranged to maintain the fluid at a below ambient pressure inside the safety casing.

In embodiments, the fuel is hydrogen.

In embodiments, the fluid is a gas preferably comprising an inert gas. The fluid could also be a liquid. The means for evacuating fluid can be a device such as a vacuum pump, a blower or a compressor. The device is arranged to suck out fluid from the atmosphere inside the safety casing i.e. the fluid filled (most often gas filled or mainly gas filed) space in between the components of the fuel cell module and the interior of the safety casing. The device can be arranged downstream from the outlet valve.

By pressure-tight it is meant that the safety casing can maintain a pressure in the fluid that is located in the space between the components of the fuel cell module and the interior of the safety casing. Air and fuel flow into the components of the fluid cell module through the safety casing via pipes and exhaust flows out of the fluid cell module through the safety casing via pipes, but these flows are isolated from the space between the components of the fuel cell module and the interior surface of the safety casing, with exception of small leaks and/or diffusion from the components of the fuel cell module into said space.

A control system can control the opening and closing of the inlet valve, the outlet valve and the means for evacuating the gas. The control system can also receive measurements from the pressure sensor.

The below ambient pressure inside the safety casing can be a pressure below ambient pressure (approximately 1 bar) preferably 0.7-0.9 bar and most preferably 0.8 bar.

One advantage of maintaining a below ambient pressure inside the safety casing is that if an explosion were to occur then the explosion would initiate inside a casing having a low initial pressure compare to the outside of the safety casing. The pressure therefore needs to increase more before the differential pressure relative to 35 the ambient/outside pressure reaches the burst pressure of the safety casing compared to an explosion starting in the same safety casing having an inside pressure equal to or higher the ambient/outside pressure.

Maintaining a below ambient pressure inside the safety casing also has the advantage that a leak is more easily detectable by the pressure sensor. All potential fluid sources for leaks have a higher pressure than the below ambient pressure of the fluid inside the safety casing. The ambient air has a higher pressure, so a leak from outside the safety casing will be detected as an increase in pressure inside the safety casing. The same goes for fuel supply and the air supply, which both have a higher pressure than the below ambient pressure inside the safety casing.

The effect of having both an inlet and an outlet compared to only having one opening into the inside space of the safety casing is that purging of the space inside the safety casing is possible. Only having an outlet will make it possible to suck out fluid/gas to reduce pressure to below ambient, but effective purging of the inside volume will not be easy.

By purging it is meant to remove the contents of pipes and/or containers and replacing it with another gas or liquid. For example, sucking in a new volume of gas into the safety casing by opening the inlet valve and the outlet valve simultaneously and operating the means for evacuating gas from the safety casing until all the gas/fluid that was in the safety casing is replaced.

The air supply system can preferably supply process air.

The casing atmosphere system can comprise an inert gas supply for providing an inert gas atmosphere inside the safety casing.

Filling the safety casing with an inert gas helps to prevent the creation of an explosive atmosphere inside the safety casing. If a leakage of only fuel takes place inside the safety casing, for example, there will not be oxygen present to create an explosive reaction.

The inert gas supply can be a nitrogen gas supply.

The nitrogen gas supply can be a nitrogen gas generator.

The nitrogen gas generator can be in fluid communication with the inlet to the safety casing upstream from the inlet valve.

The advantage of nitrogen is that it is a relatively affordable and commercially available inert gas. Nitrogen generators are also commercially available, so the nitrogen can be produced at the location where it is needed.

The system can comprise a cabinet for containing the safety casing. The cabinet may house and support the safety casing, and may completely surround the safety casing in some cases. The inert gas supply, such as a nitrogen generator, can be arranged inside the cabinet.

This inert gas supply can be positioned either inside or outside of the safety casing when it is installed inside the cabinet. This provides a compact safety and support system which is easy to transport and to install.

The safety casing can comprise a pressure relief valve arranged to let out fluid from the safety casing when the pressure inside the safety casing increases to above a threshold.

The pressure relief valve can be arranged to let out fluid from the safety casing in case the pressure increases substantially. This is an advantage in the case of an explosion/combustion inside the safety casing. In addition the safety casing can be purged even though the pump is not functioning. Fluid is then forced in to the inlet and when the pressure exceeds the opening pressure of the pressure relief valve fluid will exit the safety casing through the pressure relief valve.

The casing atmosphere system can be arranged to purge the inside of the safety casing. The purging can be done at regular intervals.

Fuel (in particular if the fuel is hydrogen gas) and air can over time diffuse from the fuel cell module and accumulate inside the safety casing where it is mixed with the fluid therein. This might, over time, create an explosive mixture of fuel and oxygen, which can ignite. By purging (i.e. refilling, flushing or displacing the gas filled volume) the inside volume of the safety casing regularly the build-up of an explosive atmosphere is avoided. So, purging the safety casing regularly has the advantage that it removes this explosive atmosphere and if an inert gas such as nitrogen is used for purging the purging also maintains the inert atmosphere.

The outlet can be arranged at a top of the safety casing.

By the top of the casing it is meant the side of the safety casing that is arranged to be at the top or uppermost when a fuel cell module is installed, and the system is operational. The outlet is preferably in the upper quarter of the safety casing and more preferably is located in the top panel of the safety casing.

Hydrogen is lighter than any other gas and therefor will rise to the top of the inside of the safety casing. So, where hydrogen is used as the fuel, by placing the outlet at the top of the safety casing it is easier to evacuate all the hydrogen from the safety casing when purging. Other fuels might also be lighter than the other fluids inside the safety casing. So, arranging the outlet at the top of the safety casing might be beneficial when other light fuels are used as well.

In addition to having the outlet at the top of the safety casing the inlet can be arranged in the bottom or close to the bottom of the safety casing. The bottom being the panel of the safety casing arranged to face downward during normal operation. The inlet is preferably in the bottom quarter of the safety casing more preferably in the bottom panel of the safety casing

CFD-simulations and testing have been performed of the purging of nitrogen in the inert gas system. The simulations show that supplying nitrogen at the bottom of the safety casing and extracting at the top ensures the inert gas volume can be exchanged such that the concentration of fuel (in particular hydrogen) and oxygen are kept at an acceptable level throughout the volume within the safety casing, while the safety casing pressure remains stable. The purged volume from the safety casing will contain the fluid, such as nitrogen, diffused hydrogen and diffused air.

The fuel supply system can comprise a fuel supply line having a narrowing flow orifice wherein a fuel pressure sensor can be arranged to detect a pressure inside the fuel supply line downstream from the narrowing flow orifice.

A narrowing orifice is a section of the line having a reduced diameter compared to the rest of the line.

Having an narrowing flow orifice upstream from a pressure sensor measuring the pressure inside the fuel supply line has the advantage that a leak in the fuel supply line downstream from the flow orifice is easier to detect. Upstream from the narrowing flow orifice the fuel supply line can be double-walled and fully welded in all connections. Inside the safety casing the fuel supply preferably has a single wall. A leak in the fuel supply line after the flow orifice will be easily detected by a loss of pressure in that part of the fuel supply line.

The fuel cell module can be a hydrogen fuel cell module.

The hydrogen fuel cell module can use hydrogen gas (H₂) as the fuel. The hydrogen fuel cell module can comprise PEM fuel cells, alkaline fuel cells or solid oxide fuel cells.

The system can further comprise a cooling system arranged to transport heat from the fuel cell module and out of the safety casing.

The cooling system can be a closed loop cooling system and wherein the fuel concentration of the closed loop can be monitored by a coolant fuel sensor. Where the fuel is hydrogen, a hydrogen concentration of the closed loop can be monitored by a coolant hydrogen sensor.

The closed loop cooling system comprises a cooling fluid. Fuel (such as hydrogen) might over time diffuse through the walls of the closed loop cooling system inside the fuel cell module and accumulate in the cooling fluid. Where the fuel is hydrogen, it is an advantage to be able to monitor the hydrogen levels in the closed loop cooling system to be able to act in time if an explosive mixture of hydrogen and oxygen is forming. The coolant hydrogen sensor can be arranged in a top of an expansion tank arranged in the closed loop of the cooling system.

The safety and support system can further comprise:
at least one sensor selected from a list consisting of:
   a temperature sensor arranged for measuring the temperature inside the safety casing and sending the measurements to a control unit,
   an oxygen sensor, arranged for measuring an oxygen level inside the safety casing and sending the measurements to the control unit,
   a fuel sensor arranged for measuring a fuel level inside the safety casing and sending the measurements to the control unit, and
   a liquid level sensor, arranged for measuring a liquid level inside the safety casing and sending the measurements to the control unit.

The fuel may be hydrogen, and the fuel sensor may be a hydrogen sensor. The fuel or hydrogen level can comprise a fuel or hydrogen concentration.

The safety and support system can further comprise a outlet hydrogen sensor arranged outside the safety casing for measuring a hydrogen level in a fluid line connected to the outlet. The outlet hydrogen sensor can be arranged for sending the measurements to the control unit.

It is desirable to be able to monitor the hydrogen level inside the safety casing (i.e. in the volume between the fuel cell module and the safety casing), but there are some challenges with placing a hydrogen sensor inside the safety casing.

One challenge is that the sensor arranged inside the safety casing will be exposed to the high temperature inside the safety casing. The hydrogen sensor may fail or give inaccurate readings due to this high temperature environment.

Another challenge is that, during normal operation of the fuel cell module, small amounts of hydrogen will leak/diffuse from the fuel cell module. A hydrogen sensor arranged inside the safety casing will constantly be exposed to this low but constant level/concentration of hydrogen. Some types of hydrogen sensors will degrade or will be used up so that they no longer is accurate or functional if constantly exposed to such a hydrogen concentration.

Another challenge is that some hydrogen sensors need to be calibrated on regular intervals, and they are arranged to do so automatically. In this calibration the normal and extremely low hydrogen concentration in ambient air is intended to be used as a low reference for the hydrogen concentration. Since a hydrogen sensor inside the safety casing is not in contact with ambient air it will be the hydrogen concentration of inside the safety casing that will be used as the low reference concentration/base line. This will in most cases work out fine, unless there is a slowly increasing hydrogen leak from the fuel cell module into the space between the safety casing and the fuel cell module. In such a situation the sensor and the affiliate controls will gradually for each calibration increase what is assumed to be the low/base line concentration of hydrogen. In other words the calibration of the hydrogen sensor will be increasingly off and a slow rise in the hydrogen concentration will not be registered.

Due to the above mentioned challenges the system can be equipped with a hydrogen sensor that is not inside the safety casing but outside the safety casing. This outlet hydrogen sensor will measure the hydrogen concentration in the fluid that exits the safety casing, for instance each time the safety casing is purged. A increase of hydrogen concentration inside the safety casing will be revealed by a increased concentration in the fluid exiting the safety casing through the outlet.

The outlet hydrogen sensor can be arranged anywhere downstream the outlet valve, preferably between the outlet valve and the means for evacuating gas from the safety casing.

The arrangement can also further be made to accommodate a flow of a secondary fluid with suitable temperature and gas concentration that can be beneficial to increase the sensor durability and/or accuracy. The secondary fluid flow may for example be inert gas or ambient air. The secondary fluid flow can be arranged in time periods when gas is not being sucked out from the safety casing.

In a preferred embodiment four safety casings (each containing a fuel cell module) is arranged in a column and shares a common means for evacuating gas from the safety casings (the means can be a vacuum pump). In such a embodiment each safety casing can have a outlet valve. So, an advantage of such a placement of the outlet hydrogen sensor is that a single hydrogen sensor can be used to monitor each of the safety casings. By matching outlet valve opening period with detection period, it can be detected from which fuel cell module the leak originates

The control unit can be configured to receive measurements from the at least one sensor, and the system can comprise:
a fuel supply shutoff valve, arranged to shut down supply of fuel to the fuel cell module in response to a fuel shutdown signal from the control unit, and
a air shutoff valve, arranged to shut down supply of air to the fuel cell in response to an air shut down signal from the control unit.

The fuel and air shutoff valves can be located at or near the boundary or wall of the safety casing. This way when the valves are closed on receipt of a fuel or air shut down signal from the control unit, additional air and/or fuel is not only prevented from travelling to the fuel cell, but is prevented from entering the safety casing, which prevents the further build-up of these substances therein.

The casing atmosphere system can be arranged to purge the inside of the safety casing when the level of oxygen and/or fuel inside the safety casing reaches a threshold. For any of the embodiments described herein, the fuel may be hydrogen.

In another aspect the invention relates to a method for preventing an explosive atmosphere inside the safety casing of the safety and support system, wherein the system comprises an inlet into the safety casing having an inlet valve for controlling intake of the fluid into the safety casing. The method comprises performing the following steps:
opening the inlet valve and the outlet valve,
operating the means for evacuating gas from the safety casing, thereby sucking fluid from the inlet through the interior of the safety casing and out the outlet,
closing the inlet valve,
keeping the outlet valve open and continuing to operate the means for evacuating gas until the pressure inside the safety casing reaches the desired below ambient pressure, and
closing the outlet valve and stopping operation of the means for evacuating gas.

An alternative method is to separate the control of inlet valve on one hand, and the outlet valve and means for evacuating gas on the other hand:
control the inlet valve with an objective to maintain the composition of gas inside the safety casing, for example by opening the valve when concentration of hydrogen or oxygen reaches a certain threshold
control the outlet valve and the means for evacuating gas with an objective to maintain the pressure inside the safety casing, for example by opening the outlet valve and activating the means for evacuating gas when the pressure reaches a certain level.

In yet another aspect the invention relates to a fuel cell system for marine applications, wherein the system comprises the safety and support system according to the first aspect and a fuel cell module installed inside the safety casing of the safety and support system.

At least two fuel cell systems can be arranged in a common cabinet for supplying electrical power to a ship. The cabinet can be arranged with a common interface for connecting the at least two fuel cell systems to the external sources of fuel and air onboard the ship and for connecting the electrical power output of the at least two fuel cell systems to the electrical consumers onboard the ship.

### DESCRIPTION OF THE FIGURES

Embodiments of the present invention will now be described, by way of example only, with reference to the following figures, wherein:

FIG. 1 shows a standard industrial fuel cell module

FIG. 2 shows a safety casing for accommodating the fuel cell module

FIG. 3 shows the fuel cell module placed inside the safety casing. The safety casing is not sealed in this drawing.

FIG. 4 shows the fuel cell module placed inside the safety casing and a lid for the safety casing ready for being bolted to the rest of the safety casing.

FIG. 5 shows the safety casing with the lid secured to the rest of the safety casing. The safety casing (including the lid) and the fuel cell module is referenced in FIG. 5 as a fuel cell system (200) although some of the components are not present or visible in the figure.

FIG. 6 shows four safety casings arranged in a vertical column with each safety casing accommodating a fuel cell module. Such a column can be mounted in a fuel cell cabinet where air supply, fuel supply, cooling and exhaust system can be arranged via manifolds to supply all four (or any other suitable number) fuel cell modules. Other supports and interface systems towards the ship can also arranged so that there is only one interface common to all fuel cell modules towards the systems on the ship.

FIG. 7 shows schematically the safety and support system.

FIG. 8 shows the casing atmosphere system schematically in relation to the safety casing

Reference numbers

| | |
|---|---|
| 1 | Safety and support system (for a fuel cell) |
| 2 | Cabinet (for one or more safety casings and associated safety and |
| | support system) |
| 10 | Safety casing (pressure-tight) |
| 11 | Temperature sensor |
| 12 | Oxygen sensor |
| 13 | Hydrogen sensor |
| 14 | Liquid level sensor |
| 15 | Lid for safety casing |
| 20 | Fuel supply system |
| 21 | Fuel supply line |
| 21 | Fuel supply line (the part of it being outside the safety casing) |
| 22 | Narrowing flow orifice |
| 23 | Fuel pressure sensor |
| 24 | Fuel supply shutoff valve |
| 25 | Outer wall of double walled fuel line |
| 30 | Air supply system |
| 31 | Air supply line |
| 32 | Air shutoff valve |
| 33 | Air filter |
| 40 | Exhaust system |
| 41 | Water separator/water condensation tank |
| 42 | Exhaust pipe |
| 43 | Line to vent mast |
| 44 | Line for process water |
| 50 | Casing atmosphere system |
| 51 | Inlet |
| 52 | Inlet valve |
| 53 | Outlet |
| 54 | Outlet valve |
| 55 | Means for evacuating gas from the safety casing (such as a pump) |
| 56 | Pressure sensor |
| 57 | Nitrogen generator |
| 58 | Safety casing overpressure check valve/pressure relief valve |
| 60 | Control unit |
| 70 | Electrical Power distribution system |
| 81 | Hydrogen diffusion |
| 82 | Oxygen diffusion |
| 83 | Flow of ambient air in and out of the cabinet 2 |
| 90 | Cooling system |
| 91 | Closed loop |
| 92 | Heat exchanger |
| 93 | Expansion tank |
| 94 | Coolant hydrogen sensor |
| 95 | Cooling pump |
| 100 | Fuel cell module |
| 110 | Local fuel cell control unit |
| 120 | Power output |
| 200 | Fuel cell system (comprising both fuel cell module 100 and |
| | safety and support system 1) |

### DESCRIPTION OF PREFERRED EMBODIMENTS OF THE INVENTION

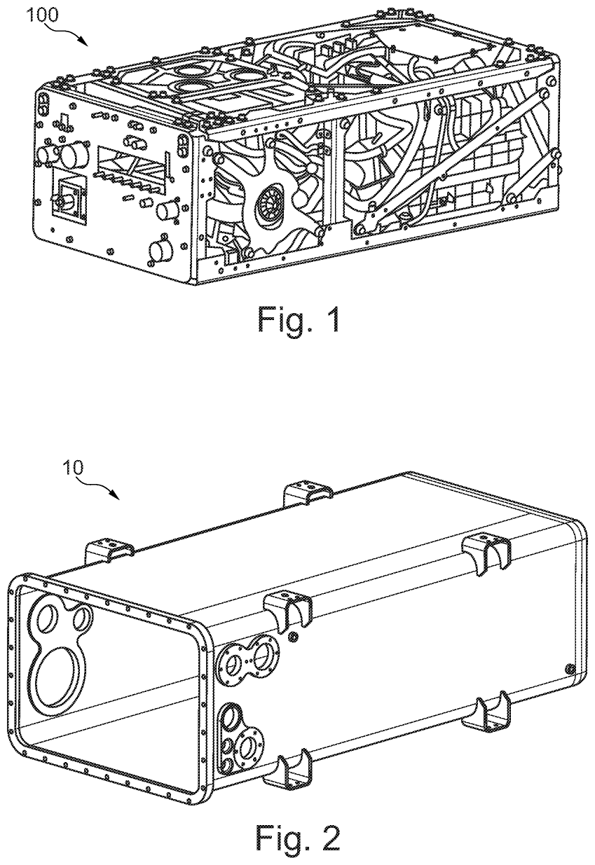

FIG. 1 shows a standard fuel cell module 100. In this embodiment the fuel cell module is a hydrogen fuel cell module where hydrogen gas is the fuel. Such a module is typically based on the components of a fuel cell system used in a hydrogen car. Such a fuel cell module 100 has capacity to produce around 80 KW of electrical power. The fuel cell module need to be supplied with air (process air as a O₂ source), hydrogen gas (H₂) and cooling. In addition to electrical current the fuel cell module 100 outputs process water and exhaust gas comprising small amounts of hydrogen gas. Small amounts of hydrogen gas will also normally leak and/or diffuse out of the fuel cell module 100. In a well ventilated area these small amounts of hydrogen gas will dispersed into the ambient air and will not accumulate to form an explosive atmosphere.

To power a ship with electricity generated from fuel cells several of the standard fuel cell modules 100 will in most cases be needed since 80 KW of power is not much in the context of a ship. Further, the typical machinery space of a ship/vessel is a confined space in contrast to a car where ambient air can flow passed the fuel cell components.

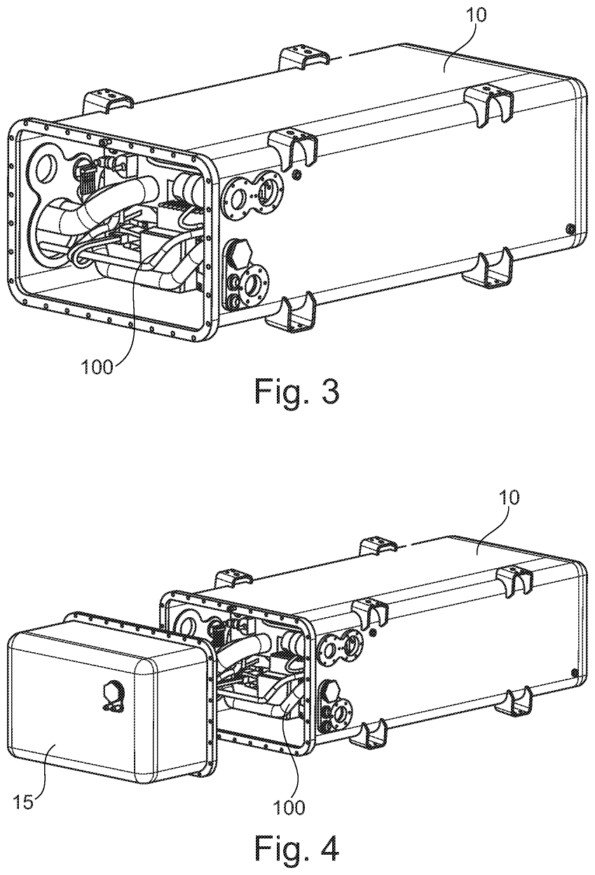

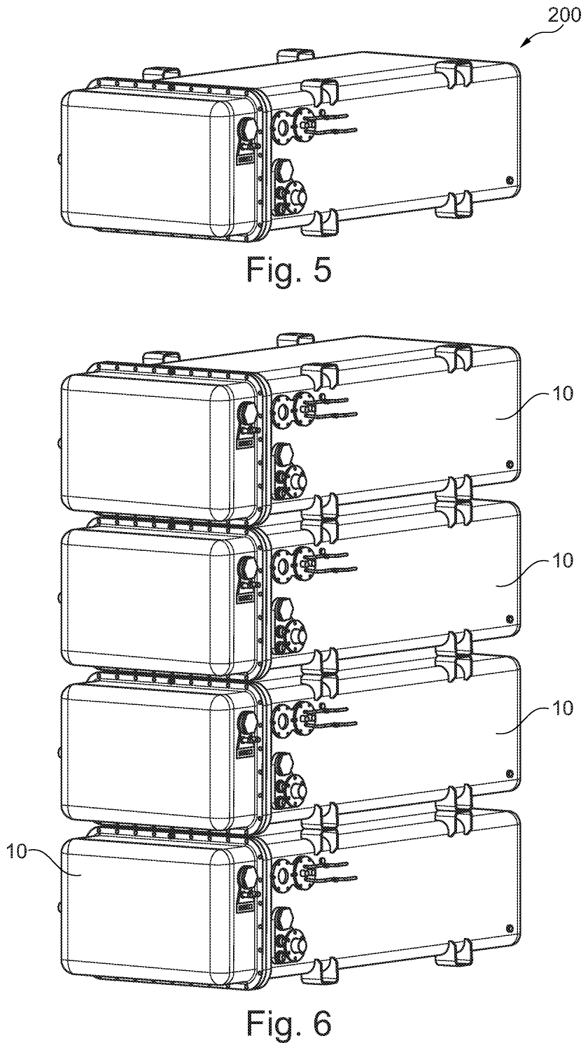

For the machinery space to be considered a gas safe space, the fuel cell module 100 is enclosed in a safety casing 10, such as the one illustrated in FIG. 2. In FIGS. 3 and 4 the fuel cell module 100 is placed inside the safety casing 10.

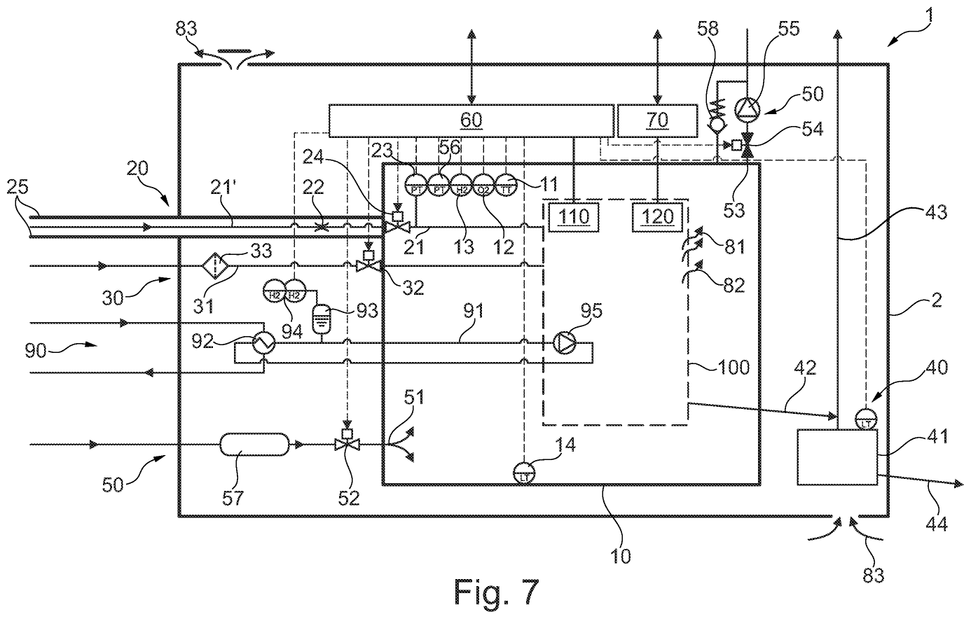

The safety casing 10 is part of a safety and support system 1 which is designed to provide the fuel cell module with fuel (hydrogen gas/H₂), air and to make sure that the machinery space where it is installed can be considered a gas safe space. An embodiment of the safety and support system is presented schematically in FIG. 7.

The main function of the safety casing 10 is to support the fuel cell module 100 and being a gas-tight container that can contain an inert atmosphere. The safety casing 10 can be designed to withstand a gas explosion inside the safety casing 10 and to protect the surroundings from the impact of such an explosion. The safety casing is preferably made from steel, but other materials can also be used.

The safety casing 10 can be equipped with a pressure relief valve 58. The pressure relief valve is arranged to let out fluid from the safety casing in case the pressure increases substantially, for instance as a result of leakage of fluid into the safety casing and/or an explosion/combustion inside the safety casing 10. In addition the safety casing can be purged even though the pump 55 is not functioning. Fluid is then forced in to the inlet 51 and when the pressure exceeds the opening pressure of the pressure relief valve fluid will exit the safety casing 10 through the pressure relief valve 58.

The safety and support system 1 is a modular system that can be adapted to support one or more fuel cell modules 100 each enclosed in a safety casing 10. One such safety and support system 1 supporting one or more, preferably four, fuel cell modules 100 can be arranged in a cabinet 2. Inside the cabinet 2 there is an auxiliary space that can house the parts of the safety and support system 1 that is not arranged inside the safety casing 10. The cabinet 2 is open to flow of ambient air 83 into and out of the cabinet 2, see FIG. 7.

The safety and support system further comprises a fuel supply system 20, an air supply system 30, an exhaust system 40, and a casing atmosphere gas system 50. The safety and support system can also comprise a control unit 60, electrical power distribution system 70 and sensors 11, 12, 13, 14. In FIG. 7 all these sub-systems can be seen schematically.

The fuel supply system 20, the air supply system 30, the exhaust system 40, and the casing atmosphere gas system 50 can be built out to support several fuel cell modules 100 each enclosed in a safety casing 10 and arranged in the cabinet 2. This can be done by providing manifolds for fuel, air and exhaust and adding in valves for each safety casing 10 inside the cabinet 2. The safety and support system 1 is in the case of several fuel cell modules 100 arranged so that there is only one interface towards the ship for each cabinet 2 (one line for supplying fuel from external source etc.).

### Fuel Supply System

The purpose of the fuel supply system 20 is to provide fuel (typically hydrogen gas/H₂) to the fuel cell modules 10. An important task is to ensure that the supply meets the required conditions in terms of flowrate, pressure, and purity.

The fuel cell module preferably has an inlet pressure of between 5 and 15 bar, preferably around 9 bar. To avoid the inlet pressure from an external fuel storage tank (external fuel supply) exceeding design inlet pressure into the fuel cell system 200, a pressure safety valve can be placed on the fuel supply pipeline 21 from the ship.

The fuel supply system 20 can further comprise a narrowing flow orifice 22 in the fuel supply line 21, a fuel supply shutoff valve 24 downstream from the narrowing flow orifice 22 and a fuel pressure sensor 23 arranged downstream from the fuel supply shutoff valve 24. This arrangement is to make sure a rupture/major leakage from the fuel line 21 downstream from the narrowing flow orifice 22, and in particular downstream of valve 24 where any rupture or damage to the piping will result in fuel leakage into the safety casing, results in a distinct drop of pressure after the narrowing flow orifice 22. Such a distinct pressure drop can be detected by the fuel pressure sensor 23 which is arranged to measure the pressure inside the fuel supply line 21 downstream from the narrowing flow orifice 22. The fuel supply shutoff valve 24 can be co-located with the flow orifice at or near to the boundary of the safety casing. In which case any large leakage downstream of the flow orifice 22 will also generally be downstream of the fuel supply shutoff valve 24, and will be detected as a sharp drop in pressure by the fuel pressure sensor 23.

The fuel supply line 21 is double walled outside of the safety casing 10, i.e. all of the way to the wall of the safety casing 10 where the fuel shutoff valve 24 is also arranged. Hence, the fuel supply line 21 upstream from the fuel shutoff valve 24 is double walled, so any leakage in the fuel supply line 21 upstream from the fuel shutoff valve 24 will be contained inside the outer wall of the double wall 25 of the fuel pipe. A leakage in the fuel line 21 downstream from the fuel shutdown valve 24 will leak into the safety casing 10. A major leakage from fuel pipes/lines in the fuel cell module itself will also be detected by the pressure sensor 23.

Between storage tank (external source of fuel) and each cabinet 2 double block & bleed valves with venting is preferred, to shut down the Fuel Cell modules 100 if a safety event appear between these valves and the safety casings 10.

The fuel supply lines 21′ (such as hydrogen supply lines) for each safety casing 10 are also double-walled and fully welded to a gas-tight flange bolted on the safety casing 10. This gives a continuous annulus between the inner and outer pipe all the way from the double block and bleed valves and to the safety casings 10. Inside the safety casings 10 the fuel supply line 21 can be single-walled.

When several fuel cell modules 100 are arranged in a cabinet 2 the fuel can be distributed in the cabinet 2 through a manifold with separate branches to each fuel cell module 100. Each branch is equipped with a dedicated fuel shutoff valve 24 for each fuel cell module 100 which is arranged to ensure safe shut-off of the supply when needed.

### Air Supply System

The purpose of the air supply system 30 is to provide oxygen to enable the electrochemical reaction in the fuel cell modules 100. An important task for the air system 30 is to secure that the supply meets the required conditions in terms of flowrate, pressure, temperature, and purity.

The air supply system 30 comprises an air supply line 31 and an air shutoff valve 32. When several fuel cell modules 100 are arranged in a cabinet 2 the air can be distributed within the cabinet 2 in a manifold with separate branches leading to each fuel cell module 100. Each inlet branch is equipped with a dedicated air shutoff valve 32 to secure a safe shut-off of the supply when needed. The shutoff valves 32 are controlled from the control unit 60.

### Exhaust System

In the exhaust system 40, the process water and exhaust gas from the fuel cell process are separated. The exhaust system 40 comprises an exhaust pipe 42 and a water condensation tank 41. The exhaust pipe 42 and the process water condensation tank 41 can be fully welded. The exhaust gas contains small amounts of hydrogen and needs to be evacuated to open air or other safe space through a line 43 to a vent mast as per specifications of the vessel/ship.

When several fuel cell modules are arranged in a cabinet 2 exhaust is led from each fuel cell module 100 into a manifold leading to the water condensation tank 41. After the water separation the exhaust gas is led to the top of the cabinet 2 via the line 43.

### Casing Atmosphere System

The purpose of the casing atmosphere system 50 is to establish and maintain an inert atmosphere at a pressure below ambient in the safety casing 10. It is important to avoid flammable mixtures, such as flammable mixtures of hydrogen and oxygen, as the probability of ignition is high if such a mixture occurs. The inert atmosphere reduces the probability of flammable mixtures inside the safety casing 10. Nitrogen is the preferred inert gas.

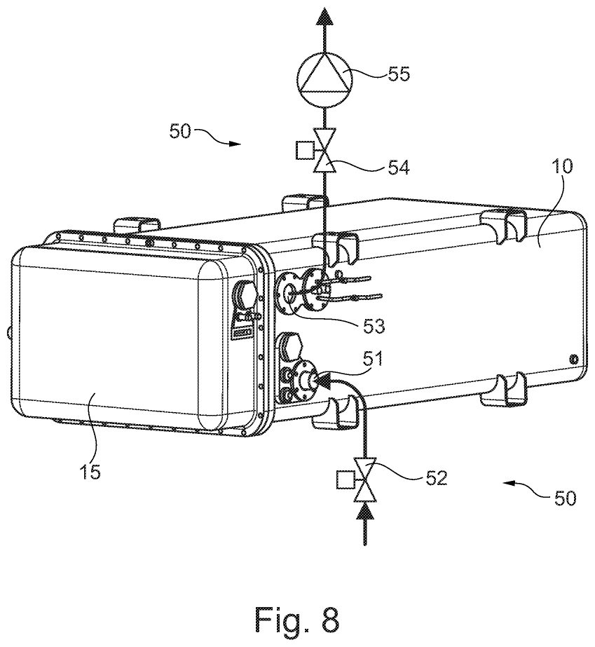

The casing atmosphere gas system 50 comprises an inlet 51 into the safety casing 10. An inlet valve 52 is arranged to control the flow of fluid (i.e. inert gas) into the safety casing 10. An outlet valve 54 controls the flow of gas out of the safety casing through an outlet 53. A pump 55 (or another air evacuation means) is arranged to draw air out from the safety casing 10 through the outlet 53 when the outlet valve 54 is open. See FIG. 7 and FIG. 8.

The pump 55 creates a pressure below ambient in the or each safety casing 10. Slow changes in the safety casing pressure are expected during normal operation due to temperature fluctuations and normal diffusion. The correct pressure is maintained close to setpoint by adjusting the amount of nitrogen in the safety casing 10. When the safety casing pressure falls below a given value, the inlet valve 52 on the inlet 51 opens to let in more nitrogen. Whereas the pump 55 starts and the outlet valve 54 on the outlet 53 opens when the safety casing pressure is too high. Operation of the pump 55 and valves 52, 54 ensures that the volume of the safety casing 10 is purged on regular intervals to ensure that the concentration of hydrogen always is kept below flammable level.

During a purging sequence the outlet valve 54 opens, pump 55 starts, and the inlet valve 52 opens. At the end of the sequence, inlet valve 52 is closed before outlet valve 54 is closed and the pump 55 stops when desired sub atmospheric pressure is reached. The pressure inside the safety casing 10 is monitored using the pressure sensor 56 and the casing atmosphere system 50 is controlled by the control unit 60 to maintain the desired below ambient pressure. Outlet valve 54 opens and the pump 55 starts on high level, while the inlet valve 52 opens to increase pressure on low level.

### Cooling System

The purpose of the cooling system 90 is to secure to stable operational temperatures in the fuel cell module 100 by removing excess heat. A pump 95 controls the total coolant flowrate based on power request, while 3-way valve is controlled to balance the flowrate between a bypass and heat exchanger 92 to achieve the optimal inlet temperature on the inlet of the fuel cell module 100.

The cooling system 90 comprises a closed loop 91 which comprises the heat exchanger 92 and an expansion tank 93. When several fuel cell modules 100 are arranged in a cabinet 2, the coolant can be distributed through a manifold with parallel branches through each of the fuel cell modules 100 and the expansion tank 93 can be common for the cabinet 2. Each of the branches can be equipped with water pump and manual valves on both inlet and outlet to be able to connect/disconnect the flow individually through the fuel cell modules 100.

### Leak Detection Principle

To detect leaks several sensors are arranged in the safety and support system 1. In addition to the pressure sensor 56 and the fuel pressure sensor 23 the following sensors are arranged to monitor the inside to the safety casing 10: a temperature sensor 11, a oxygen sensor 12, a hydrogen sensor 13 and a liquid level sensor 14.

To detect and avoid the formation of a explosive mixture of hydrogen and oxygen the following leakage detection principles are implemented:

Air ingress into safety casing 10 (External leak): Detected by pressure sensor 56 and oxygen sensor 12.

Air ingress into the safety casing 10 (from air supply system 30): Detected by pressure sensor 56 and oxygen sensor 12.

Hydrogen ingress into safety casing 10 (Small diffusion leak): Detected by hydrogen sensor 13.

Hydrogen ingress into safety casing 10 (Large leak): Detected by pressure sensor 56, pressure sensor 23 and hydrogen sensor 13.

Coolant water and exhaust water ingress into safety casing 10: Detected by moisture/liquid level sensor 14 (Also pressure sensor 56 at large leaks).

Exhaust ingress into safety casing 10: Detected by pressure sensor 56, oxygen sensor 12 and moisture sensor/liquid level sensor 14.

In addition to or instead of the hydrogen sensor 13 a outlet hydrogen sensor can be arranged in a outlet line connected to the outlet 53. Then the hydrogen concentration in the gas exiting the safety casing can be monitored to reveal leaks from within the safety casing 10.

The control unit 60 is arranged to define if the detected scenario will lead to shutdown and isolation of each single safety casing independently by closing valves 24 and 32.

The safety and support system 1 is above described used with a hydrogen fuel cell. A hydrogen fuel cell can be fuel cells 100 such as PEM fuel cells, alkaline fuel cells or solid oxide fuel cells. The safety and support system 1 can also be used for other types of fuel cells. Example of other such fuel cells can be, but is not limited to: natural gas fuel cells, ammonia fuel cells and methanol fuel cells.

1. A safety and support system (1) for a fuel cell module (100) comprising:
a pressure-tight safety casing (10) for enclosing the fuel cell module (100) and for containing a fluid in a space between the fuel cell module (100) and the safety casing (10),
a fuel supply system (20), arranged to transport fuel to the fuel cell module (100) from an external source outside the safety casing (10),
an air supply system (30), arranged to transport air to the fuel cell module (100) from an external source outside the safety casing (10),
an exhaust system (40), arranged to transport exhaust fluids from the fuel cell module (100) out of the safety casing (10) isolated from the space between the fuel cell module (100) and the safety casing (10), and
a casing atmosphere system (50) comprising:
an outlet (53) from the safety casing (10) having an outlet valve (54),
an inlet (51) having an inlet valve (52) for controlling intake of the fluid into the safety casing (10),
means (55) for evacuating the fluid from the safety casing (10) through the outlet (53), and
a pressure sensor (56), arranged for measuring a pressure of the fluid inside the safety casing (10),
wherein the casing atmosphere system (50) is arranged to maintain a below ambient pressure inside the safety casing (10).

2. The safety and support system (1) according to claim 1, wherein the casing atmosphere system (50) comprises an inert gas supply for providing an inert gas atmosphere inside the safety casing (10).

3. The safety and support system (1) according to claim 2, wherein the inert gas supply is a nitrogen gas supply.

4. The safety and support system (1) according to claim 3, wherein the nitrogen gas supply is a nitrogen generator (57).

5. The safety and support system (1) according to claim 2, comprising a cabinet (2) for containing the safety casing, wherein the inert gas supply is arranged inside the cabinet (2).

6. The safety and support system (1) according to claim 1, wherein the safety casing (10) comprises a pressure relief valve (58) arranged to let out fluid from the safety casing (10) when the pressure inside the safety casing (10) increases to above a threshold.

7. The safety and support system (1) according to claim 1, wherein the casing atmosphere system (50) is arranged to purge the inside of the safety casing (10).

8. The safety and support system (1) according to claim 1, wherein the outlet (53) is arranged at a top of the safety casing (10).

9. The safety and support system (1) according to claim 1, wherein the fuel supply system (20) comprises a fuel supply line (21) having a narrowing flow orifice (22) wherein a fuel pressure sensor (23) is arranged to detect a pressure inside the fuel supply line (21) downstream from the narrowing flow orifice (22).

10. The safety and support system (1) according to claim 1, wherein the fuel cell module (100) is a hydrogen fuel cell module.

11. The safety and support system (1) according to claim 10, wherein the safety and support system (1) further comprises a cooling system arranged to transport heat from the fuel cell module (100) and out of the safety casing.

12. The safety and support system (1) according to claim 11, wherein the cooling system (90) is a closed loop (91) cooling system and wherein a hydrogen concentration in the closed loop (91) is monitored by a coolant hydrogen sensor (94).

13. The safety and support system (1) according to claim 10, wherein the system (1) further comprises:
at least one sensor selected from a list consisting of:
a temperature sensor (11) arranged for measuring the temperature inside the safety casing (10) and sending the measurements to a control unit (60),
an oxygen sensor (12), arranged for measuring an oxygen level inside the safety casing (10) and sending the measurements to the control unit (60),
a hydrogen sensor (13) arranged for measuring a hydrogen level inside the safety casing (10) and sending the measurements to the control unit (60), and
a liquid level sensor (14), arranged for measuring a liquid level inside the safety casing (10) and sending the measurements to the control unit (60).

14. The safety and support system (1) according to claim 10, further comprising a outlet hydrogen sensor arranged outside the safety casing (10) for measuring a hydrogen level in a fluid line connected to the outlet (53), and wherein the outlet hydrogen sensor is arranged for sending the measurements to the control unit (60).

15. The safety and support system (1) according to claim 14, wherein the outlet hydrogen sensor is arranged between the outlet valve (54) and the means (55) for evacuating gas from the safety casing (10).

16. The safety and support system (1) according to claim 13, wherein
the control unit (60) is configured to receive measurements from the at least one sensor (11, 12, 13, 14), and the system comprises:
a fuel supply shutoff valve (24), arranged to shut down supply of fuel to the fuel cell module (100) in response to a fuel shutdown signal from the control unit (60), and
an air shutoff valve (32), arranged to shut down supply of air to the fuel cell in response to an air shut down signal from the control unit (60).

17. The safety and support system (1) according to claim 1, wherein the casing atmosphere system (1) is arranged to purge the inside of the safety casing (10) when the level of oxygen and/or fuel inside the safety casing (10) reaches a threshold.

18. A method for preventing an explosive atmosphere inside the safety casing (10) of the safety and support system (1) according to claim 1, the method comprising performing the following steps:
opening the inlet valve (52) and the outlet valve (54)
operating the means (55) for evacuating gas from the safety casing (10), thereby sucking fluid from the inlet (51) through the interior of the safety casing (10) and out the outlet (53),
closing the inlet valve (52),
keeping the outlet valve (54) open and continuing to operate the means (55) for evacuating gas until the pressure inside the safety casing (10) reaches the desired below ambient pressure, and
closing the outlet valve (54) and stopping operation of the means (55) for evacuating gas.

19. A fuel cell system (200) for marine applications, wherein the system (200) comprises the safety and support system (1) according to claim 1 and a fuel cell module (100) installed inside the safety casing (10) of the safety and support system (1).

20. The fuel cell system (200) according to claim 19, wherein at least two fuel cell systems (200) are arranged in a common cabinet (2) for supplying electrical power to a ship, wherein the cabinet (2) is arranged with a common interface for connecting the at least two fuel cell systems to the external sources of fuel and air onboard the ship and for connecting the electrical power output of the at least two fuel cell systems to the electrical consumers onboard the ship.
